(19) United States
(12) Patent Application Publication
(10) Pub. No.: US 2011/0095547 A1
(43) Pub. Date: Apr. 28, 2011

(54) BATTERY COVER LATCHING MECHANISM

(75) Inventors: JUN-FANG LIU, Shenzhen City (CN); MING-ZHI ZHENG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/730,319

(22) Filed: Mar. 24, 2010

(30) Foreign Application Priority Data
Oct. 22, 2009 (CN) 200910308624.9

(51) Int. Cl. E05C 1/08

(52) U.S. Cl. 292/277

(57) ABSTRACT

A battery cover latching mechanism is provided. The battery cover latching mechanism includes a body member, a battery cover and a releasing piece. The body member defines a battery chamber and has an elastic body disposed adjacent to the battery chamber for providing an ejecting elastic force. The battery cover is detachably attached to the body member to cover the battery chamber. The releasing piece is slidably mounted to the body member and elastically resists against the elastic body. As the releasing piece is released, the battery cover is ejected to detach from the body member.

### BACKGROUND

1. Technical Field

The present disclosure relates to battery cover latching mechanisms and, particularly, to a battery cover latching mechanism used in a portable electronic device.

2. Description of Related Art

Batteries provide power to portable electronic devices, e.g., mobile phones. Battery cover latching assemblies secure batteries within portable electronic devices.

A typical battery cover latching assembly for an electronic device usually includes a battery cover and latching means, e.g., a locking pin latching into a locking hole. The battery cover can detachably mount to a housing of portable electronic devices using the latching means.

However, removal of the battery cover may require a strong force, which may damage the locking pin.

Therefore, there is room for improvement within the art.

### BRIEF DESCRIPTION OF THE DRAWINGS

Many aspects of the present disclosure can be better understood with reference to the following drawings. These drawings are not necessarily drawn to scale, the emphasis instead being placed upon clearly illustrating the principles of the present battery cover latching mechanism. Moreover, in the drawings like reference numerals designate corresponding sections throughout the several views.

FIG. 1 is an exploded, isometric view of a battery cover latching mechanism, in accordance with an exemplary embodiment.

FIG. 2 is similar to FIG. 1, but viewed from another aspect.

FIG. 3 is an assembled view of the battery cover latching mechanism, the battery cover locks to the housing.

FIG. 4 is similar to FIG. 3, but showing another working status of the battery cover latching mechanism where the battery cover is detached from the housing.

### DETAILED DESCRIPTION

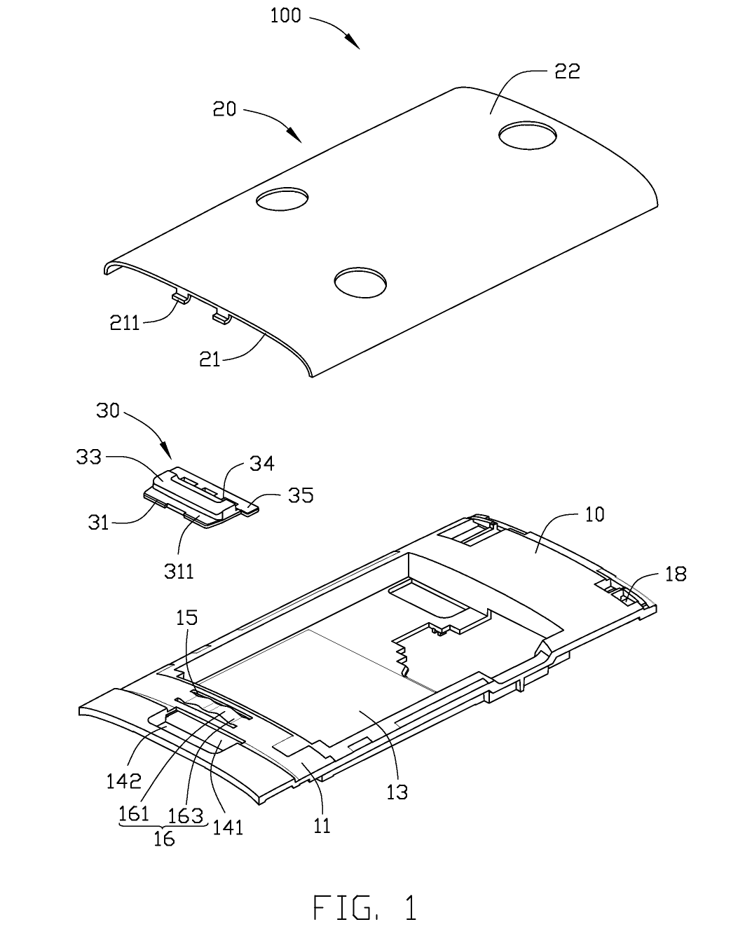

FIG. 1 shows an exemplary battery cover latching mechanism 100 including a body member 10, a battery cover 20, and a releasing piece 30. The battery cover 20 detachably mounts on the body member 10. The releasing piece 30 assembles to the body member 10, and releasably locks the battery cover 20 to the body member 10.

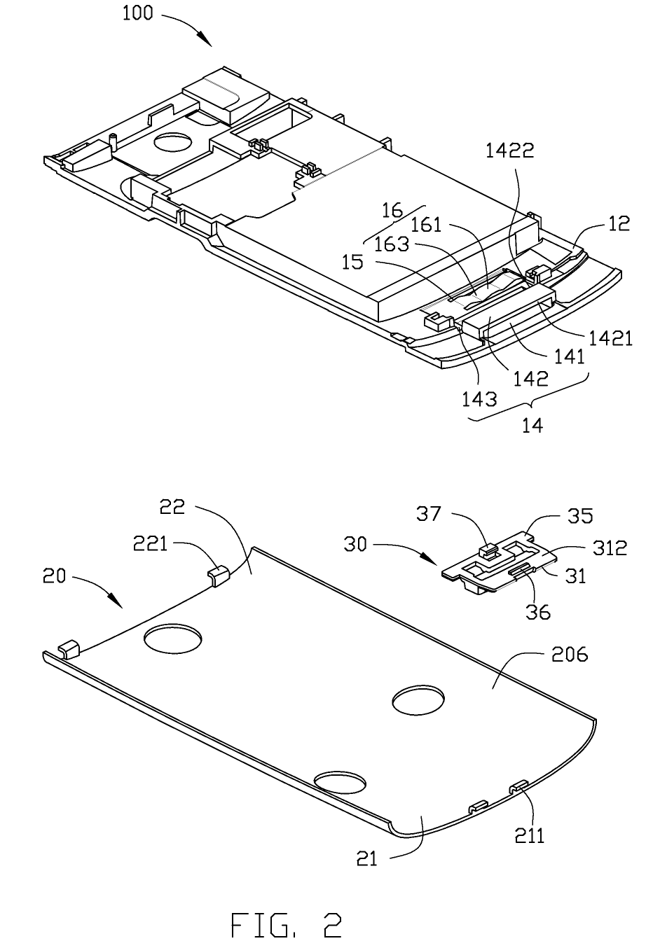

Referring further to FIG. 2, the body member 10 can be a housing of a portable electronic device, e.g., a mobile phone. The body member 10 includes an outer surface 11, an inner surface 12 opposite to the outer surface 11, an assembling portion 14, and an elastic body 16. The outer surface 11 defines a battery chamber 13 for receiving a battery (not shown). The assembling portion 14 is formed on the outer surface 11 of one end of the body member 10, adjacent to the battery chamber 13. The assembling portion 14 includes a receiving hole 141, a resisting frame 142, and two sliding grooves 143. The receiving hole 141 defines through the outer surface 11 of the end of the body member 10, adjacent to the battery chamber 13. The resisting frame 142 is substantially U-shaped, protruding from the inner surface 12 and extending above the receiving hole 141. The resisting frame 142 is located adjacent to the end of the body member 10. The resisting frame 142 includes a first side surface 1421 at the end of the body member 10 and an opposite second side surface 1422 facing the battery chamber 13. The two sliding grooves 143 are defined at two sides of the receiving hole 141 of the inner surface 12 of the body member 10 and positioned parallel to two ends of the resisting frame 142 toward the battery chamber 13. Positioned between the assembling portion 14 and the battery chamber 13. The body member 10 further includes two latching slots 18 defined at the opposite end of the body member 10.

The elastic body 16 is wave-shaped and made of elastic plastic material. The elastic body 16 is formed by extending two opposite inside surfaces of the through gap 15. The elastic body 16 is partially accommodated within the through gap 15. The elastic body 16 includes a plurality of convex portions 161 and a plurality of spaced concave portions 163. The convex portions 161 extend out from the through gap 15.

The battery cover 20 detachably attaches to the body member 10 by the releasing piece 30. The battery cover 20 includes a first end 21, an opposite second end 22, and an assembling surface 26. The assembling surface 26 corresponds to the outer surface 11 of the body member 10. Two substantially L-shaped latching hooks 211 are formed at the assembling surface 26 of the first end 21 of the battery cover 20. The latching hooks 211 are spaced from each other for latching the battery cover 20 to the body member 10. Two catches 221 are spaced and formed on the opposite second end 22 of the battery cover 20. The catches 221 are for inserting into the two latching slots 18 of the body member 10 respectively.

The releasing piece 30 slidably assembles within the assembling portion 14 of the body member 10 for assembling the battery cover 20 to the body member 10 and/or detaching the battery cover 20 from the body member 10. The releasing piece 30 includes a main body 31, an operating block 33, two latching grooves 34, two sliding blocks 35, a latching bar 36 and a latching clasp 37. The main body 31 is generally a rectangular board and has a first surface 311 and a second surface 312 opposite to the first surface 311. The operating block 33 is generally rectangular and protrudes from the first surface 311 of the main body 31. The operating block 33 is for insertion into the corresponding receiving hole 141 and exposes above the outer surface 11 of the body member 10. The two latching grooves 34 recess from the first surface 311 of the main body 31. The latching grooves 34 are spaced from each other, adjacent to the operating block 33. The two sliding blocks 35 are generally rectangular, protruding from two opposite sides of the main body 31, adjacent to the two latching grooves 34 respectively. The two sliding blocks 35 slidably engage with the corresponding two sliding grooves 143. The latching bar 36 protrudes from the second surface 312 of the main body 31 for resisting against the first side surface 1421 of the resisting frame 142. The latching clasp 37 protrudes from the second surface 312 of the main body 31, opposite to the latching bar 36 and between the two sliding blocks 35.

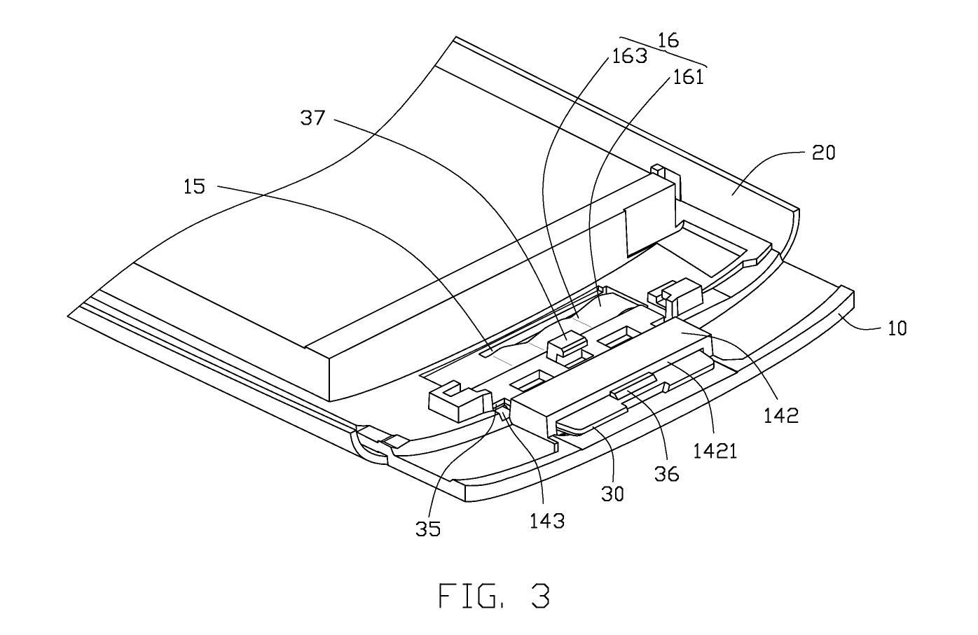

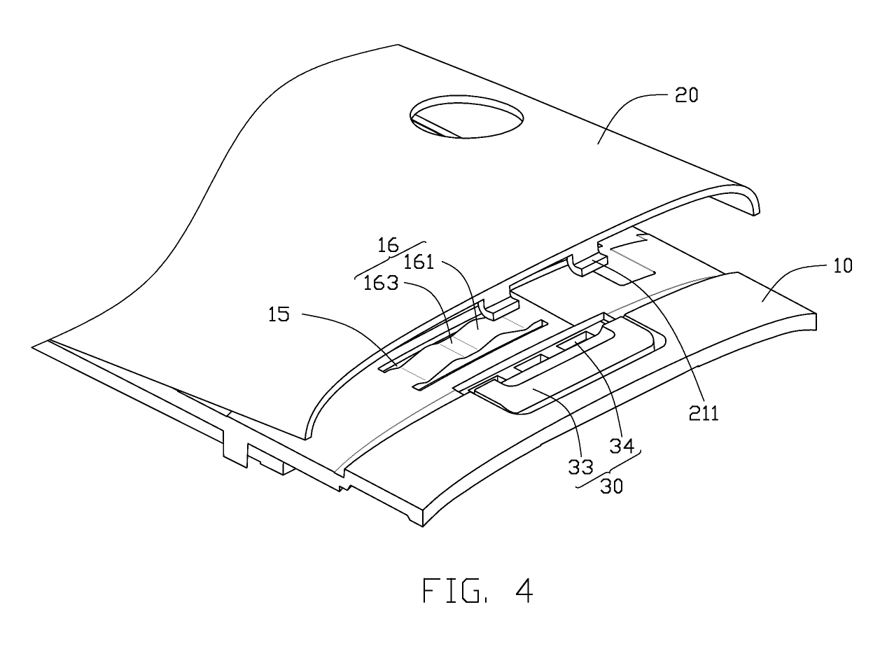

Referring to FIGS. 3 and 4, in assembly, the releasing piece 30 is inserted and accommodated into the receiving hole 141 of the body member 10 from the side of the inner surface 12. The operating block 33 of the releasing piece 30 exposes above the outer surface 11 side of the body member 10. The latching bar 36 resists against the first side surface 1421 of the resisting frame 142. The two sliding blocks 35 slidably assemble to the two sliding grooves 143 of the body member 10. The latching clasp 37 positions towards the second side surface 1422.

To attach the battery cover 20 to the body member 10, the battery cover 20 is placed above the battery chamber 13. The two catches 221 are latched into their respective latching slots 18 of the body member 10. By pressing downwardly and then sliding the battery cover 30 relative to the body member 10, the battery cover 30 is moved toward the assembling portion 14 end, and the two latching hooks 211 latch into the two latching grooves 34 respectively. In this case, the assembling surface 26 resists against the convex portions 161 of the elastic body 16.

To detach the battery cover 20 from the body member 10, the operating block 33 is pushed to slide the releasing piece 30 apart from battery cover 20. Accordingly, the two sliding blocks 35 slide along the two sliding grooves 143 of the body member 10 toward the receiving hole 141 of the body member 10. As the latching clasp 37 slides and resists against the second side surface 1422 of the resisting frame 142, the two latching hooks 211 of the battery cover 20 detach from the two latching grooves 34 of the releasing piece 30 respectively. The convex portions 161 of the elastic body 16 reverse to its original state and ejects the battery cover 20 away from the body member 10. Thus, the battery cover 20 detaches from the body member 10.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.]

What is claimed is:

1. A battery cover latching mechanism, comprising:
a body member defining a battery chamber and having an elastic body adjacent to the battery chamber for providing an ejecting elastic force;
a battery cover detachably attached to the body member to cover the battery chamber; and
a releasing piece slidably mounted to the body member and elastically resisting on the elastic body, whereby as the releasing piece is released, the battery cover is ejected to detach from the body member.

2. The battery cover latching mechanism as claimed in claim 1, wherein the body member includes an outer surface, an opposite inner surface and a gap defined through the body member; the elastic body is substantially wave-shaped.

3. The battery cover latching mechanism as claimed in claim 2, wherein the elastic body includes a plurality of convex portions and a plurality of concave portions arranged spaced to each other, the convex portions extend out from the through gap.

4. The battery cover latching mechanism as claimed in claim 2, wherein the body member includes an assembling portion formed on the outer surface of one end of the body member adjacent to the battery chamber; the gap is positioned between the assembling portion and the battery chamber; the releasing piece is slidably assembled within the assembling portion of the body member.

5. The battery cover latching mechanism as claimed in claim 4, wherein the assembling portion includes a receiving hole defined through the body member and a resisting frame; the resisting frame protrudes from the inner surface of the body member and extends above the receiving hole; the releasing piece includes a main body and a latching bar; the latching bar protrudes from a first surface of the main body and is configured for resisting against the resisting frame.

6. The battery cover latching mechanism as claimed in claim 5, wherein the resisting frame is substantially U-shaped and includes a first side surface at the end of the body member and an opposite second side surface facing the battery chamber; the latching bar resists against the first side surface, the releasing piece further includes a latching clasp; the latching clasp is spaced disposed at the same surface of the main body with the latching bar and is configured for resisting against the second side surface of the resisting frame as the releasing piece is released.

7. The battery cover latching mechanism as claimed in claim 6, wherein the assembling portion further includes two sliding grooves defined at two sides of the receiving hole of the inner surface of the body member and positioned parallel to two ends of the resisting frame toward the battery chamber; the releasing piece further includes an operating block and two sliding blocks, the operating block protrudes from an opposite second surface of the main body for being inserted into the receiving hole and exposes above the outer surface of the body member; the two sliding blocks protrude from two object sides of the main body for being slidably engaged with the two sliding grooves.

8. The battery cover latching mechanism as claimed in claim 7, wherein the releasing piece further includes two latching grooves recessed from the first surface of the main body space to each other; the battery cover includes a first end, an opposite second end, and an assembling surface corresponding to the outer surface of the body member; the battery cover includes two latching hooks formed at the assembling surface of the first end of the battery cover spaced to each other for latching with the corresponding two latching grooves of the releasing piece.

9. The battery cover latching mechanism as claimed in claim 8, wherein the battery cover further includes two catches spaced from each other on the opposite second end thereof, the body member further includes two latching slots defined at the other opposite end of the body member for attaching the battery cover there to.

10. A battery cover latching mechanism, comprising:
a body member including an outer surface, an opposite inner surface and an assembling portion formed on the outer surface thereof;
a wave-shaped elastic body disposed adjacent to the assembling portion for providing an ejecting elastic force;
a battery cover detachably attached to the outer surface of the body member; and
a releasing piece slidably assembled within the assembling portion of the body member and elastically resisting against the elastic body for attaching the battery cover to the body member, as the releasing piece is released, the battery cover is ejected to detach from the body member.

11. The battery cover latching mechanism as claimed in claim 10, wherein the body member further includes a battery chamber defined therein adjacent to the assembling portion, a gap defined through the outer surface of the body member and positioned between the assembling portion and the battery chamber; the elastic body is formed by extending two opposite inside surfaces of the through gap and includes a plurality of spaced convex portions extend out from the through gap.

12. The battery cover latching mechanism as claimed in claim 11, wherein the assembling portion includes a receiving hole defined through the body member and a resisting frame; the resisting frame protrudes from the inner surface of the body member and extends above the receiving hole; the releasing piece includes a main body and a latching bar; the latching bar protrudes from a first surface of the main body and is configured for resisting against the resisting frame.

13. The battery cover latching mechanism as claimed in claim 12, wherein the resisting frame includes a first side surface at the end of the body member and an opposite second side surface facing the battery chamber; the latching bar resists against the first side surface.

14. The battery cover latching mechanism as claimed in claim 13, wherein the assembling portion further includes two sliding grooves defined in the inner surface of the body member adjacent to the two sides of the receiving hole; the releasing piece further includes an operating block and two sliding blocks, the operating block protrudes from an opposite second surface of the main body for being inserted into the receiving hole and exposes out from the outer surface of the body member; the two sliding blocks protrude from two object sides of the main body for being slidably engaged with the two sliding grooves.

15. The battery cover latching mechanism as claimed in claim 14, wherein the releasing piece further includes two latching grooves recessed from the first surface of the main body; the battery cover includes a first end, an opposite second end, and an assembling surface corresponding to the outer surface of the body member; the battery cover includes two latching hooks formed at the assembling surface of the first end of the battery cover spaced from each other for latching with the corresponding two latching grooves of the releasing piece.
